(19) United States
(12) Patent Application Publication
(10) Pub. No.: US 2022/0005007 A1
(43) Pub. Date: Jan. 6, 2022

(54) ELECTRONIC DEVICE, SERVER, AND DIGITAL CONTENT PURCHASE METHOD

(71) Applicant: SAMSUNG ELECTRONICS CO., LTD., Suwon-si, Gyeonggi-do (KR)

(72) Inventors: Seokjae OH, Suwon-si, Gyeonggi-do (KR); Doyoung KIM, Suwon-si, Gyeonggi-do (KR); Hokyung KIM, Suwon-si, Gyeonggi-do (KR); Jinju LIM, Suwon-si, Gyeonggi-do (KR); Miang JEON, Suwon-si, Gyeonggi-do (KR); Dongil MO, Suwon-si, Gyeonggi-do (KR); Seokwon OH, Suwon-si, Gyeonggi-do (KR); Hojin LEE, Suwon-si, Gyeonggi-do (KR)

(21) Appl. No.: 17/291,484

(22) PCT Filed: Nov. 11, 2019
(86) PCT No.: PCT/KR2019/015281

§ 371 Date: May 5, 2021

(30) Foreign Application Priority Data
Nov. 13, 2018 (KR) 10-2018-0138633

(51) Int. Cl. G06Q 20/12; G06Q 20/40; G16Y 10/75; G16Y 10/45

(52) U.S. Cl. CPC G06Q 20/123; G06Q 20/4015; G06F 3/0482; G16Y 10/45; G16Y 10/75

(57) ABSTRACT

An electronic apparatus purchasing digital content separately from use or consumption is disclosed. The electronic apparatus includes a display, a communication interface configured to communicate with a server, a user input interface configured to receive a user input, and a processor configured to: based on a user input requesting a purchase of the digital content via a logged-in first user account, receive information on purchasable digital content from the server; control the display to, based on the received information on the purchasable digital content, display a user interface (UI) indicating the information on the purchasable digital content and information on an external apparatus and a second user account of the external apparatus, which are capable of using the digital content, and based on the user input using the UI, transmit information on a digital content selected to be purchased and information on selected external apparatus and second user account to the server.

### TECHNICAL FIELD

The disclosure relates to an electronic apparatus for purchasing a digital content separately from use, a server for selling the digital content, and a method of purchasing the digital content.

### BACKGROUND ART

In recent years, with the development of digital culture, various digital contents and electronic apparatuses are spreading. Sellers of digital contents are restricting only one electronic apparatus to use one digital content due to risks of infinite copying and distribution according to characteristics of the digital contents.

An electronic apparatus that purchases digital content and an electronic apparatus that uses the purchased content may be different from each other. Users may often purchase digital content for use in a TV, for example, from a mobile device, depending on a portable function and the convenience of interface operation. In general, since a TV is used by a plurality of users, a plurality of user accounts for one TV are registered in a server, whereas a mobile device is used for each individual, so one user account is registered in the server. In this case, if the TV is logged in with the first account and digital content is purchased from the mobile device logged in with the second account, the digital content may not be used on the TV. Although the situation has been described simply as a TV and a mobile device, the situation may continue to occur even when digital content is used in an IoT device without a display.

As described above, in the related art, there is a situation in which in order to purchase digital content, a second account of electronic apparatus consuming digital content needs to be changed to a first account of an electronic apparatus purchasing the digital content, or conversely, there is an inconvenience of changing the first account of the electronic apparatus purchasing the digital content to the second account of the electronic apparatus consuming the digital content. Accordingly, when the second account of the electronic apparatus consuming the digital content is changed to the first account purchasing the digital content, a usage history of the electronic apparatus consuming the digital content is newly changed to the first account, and as a result, the experience of using the existing second account may be interrupted. In addition, the change to the second account of the electronic apparatus using the digital content has also a problem in that it is necessary to, in advance, check what is the second account of the electronic apparatus using the digital content.

### DISCLOSURE

### Technical Problem

An object of the disclosure is to provide an electronic apparatus capable of identifying a type of purchased content in advance at the time of purchase when an electronic apparatus purchasing digital content and an electronic apparatus using the purchased content are different from each other, an electronic apparatus capable of using the purchased content based on the identified type of purchased content, an electronic apparatus capable of providing a user account list to use ownership of the purchased content, and an electronic apparatus capable of registering the purchased content with a user account, a server, and a method of purchasing digital content.

### Technical Solution

According to an aspect of the present disclosure, there is provided an electronic apparatus. The electronic apparatus includes a display; a communication interface configured to communicate with a server; a user input interface configured to receive a user input; and a processor configured to: based on a user input requesting a purchase of the digital content via a logged-in first user account, receive information on purchasable digital content from the server, control the display to, based on the received information on the purchasable digital content, display a user interface (UI) indicating the information on the purchasable digital content and information on an external apparatus and a second user account of the external apparatus, which are capable of using the digital content, and based on the user input using the UI, transmit information on a digital content selected to be purchased and information on selected external apparatus and second user account to the server

The communication interface may be configured to perform network communication with the available external apparatus through a router, and the processor may be configured to obtain the information on the external apparatus searched in the network.

The processor may be configured to search for the second user account of the external apparatus and display the UI indicating the information on the second user account of the external apparatus on the display.

The information on the available external apparatus and the second user account of the external apparatus may be transmitted from the server. In this case, the server may be configured to provide the information on the available external apparatus and the second user account managed by being linked with the electronic apparatus the first user account, which purchase the content.

The external apparatus may include an IoT device, and the server may be configured to provide the purchased digital content to a server of the IoT device so that a user input tool can easily purchase the content for the weak IoT device.

The processor may be configured to transmit information on a location of the electronic apparatus to the server, and receive information on an available external apparatus corresponding to the location of the electronic apparatus from the server.

The information on the selected external apparatus and the second user account may be received by the user input.

According to another aspect of the present disclosure, there is provided a server for selling a digital content. The server includes a processor configured to: based on a purchase request for digital content of the electronic apparatus logged in with a first user account, transmit information on purchasable digital content to the electronic apparatus; and receive from the electronic apparatus, information on digital content to be purchased and information on an external apparatus using the digital content to be purchased and a second user account of the external apparatus, and register the information on the digital content to be purchased with the second user account of the external apparatus to be used.

The information on an external apparatus and a second user account of the external apparatus that can use the digital content may be transmitted to the electronic apparatus.

The server may further include a storage, and the processor may be configured to connect the external apparatus and the second user account received from the electronic apparatus, to the electronic apparatus and the first user account, and store the external apparatus and the second user account in the storage.

The storage may be configured to, based on a location, store the information on the external apparatus and the second user account, which are capable of using the digital content.

The processor may be configured to, upon receiving information on a location of the electronic apparatus, transmit information on an external apparatus and a second user account capable of using in response to a location of the electronic apparatus, to the electronic apparatus.

The processor may be configured to push and transmit the digital content to the external apparatus and the second user account.

According to still another aspect of the present disclosure, there is provided a method of purchasing a digital content. The method of purchasing the digital content includes logging in to a server with a first user account to request a purchase of purchasable digital content; receiving information on the purchasable digital content from the server; based on the received information on the purchasable digital content, displaying, on a display, a user interface (UI) indicating the information on the purchasable digital content and information on an external apparatus and a second user account of the external apparatus, which are capable of using the purchasable digital content; and based on a user input using the UI, transmitting information on a digital content selected to be purchased and information on an external apparatus and an second user account selected to use the digital content to the server.

The method may further include transmitting location information of the electronic apparatus to the server, and searching available external apparatus and second user account based on the location information.

### Advantageous Effects

As described above, according to the disclosure, the purchase and use of content can each be performed without separately changing the user account that purchases the content and the user account that uses the content.

In addition, the connection can be made without interrupting the user experience when using other user accounts of various devices in the sale of user account-based content.

### DESCRIPTION OF DRAWINGS

FIG. 1 is a schematic diagram of a system for purchasing, selling, and using digital content according to a first embodiment of the disclosure.

FIG. 2 is a block diagram of a system for purchasing, selling, and using digital content of FIG. 1.

FIG. 3 is a block diagram illustrating a configuration of a second processor of a server according to the first embodiment of the disclosure.

FIG. 4 is a flowchart of a process of purchasing, selling, and using digital content according to the first embodiment of the disclosure.

FIGS. 5 to 7 are diagrams illustrating a UI displayed on a display of an electronic apparatus according to the first embodiment of the disclosure.

FIG. 8 is a flowchart of a scenario for purchasing, selling, and using digital content according to a second embodiment of the disclosure.

FIG. 9 is a schematic diagram of a system for purchasing, selling, and using digital content according to a third embodiment of the disclosure.

FIG. 10 is a flowchart of a scenario for purchasing, selling, and using digital content according to the third embodiment of the disclosure.

### MODE FOR DISCLOSURE

Hereinafter, embodiments according to the disclosure will be described in detail with reference to the accompanying drawings. The description of embodiments below references matters described in the accompanying drawings, and the same reference numerals or symbols illustrated in each drawing indicate components that perform substantially the same operation.

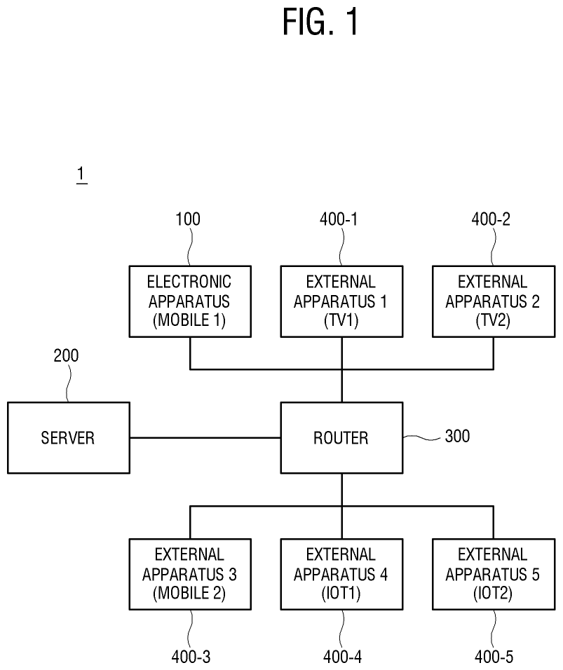

FIG. 1 is a schematic diagram of a system 1 for purchasing, selling, and using a digital content according to a first embodiment of the disclosure. The system 1 includes an electronic apparatus 100 as a purchasing terminal for purchasing the digital content, a server 200 for selling or distributing the digital content, a router 300, and a plurality of external apparatuses 400-1 to 400-5.

The electronic apparatus 100 may be implemented as a mobile device 1. The electronic apparatus 100 may also include, for example, a TV, a computer, a notebook, a smart phone, a tablet, a mobile phone, a smart watch, a wearable device, a computer, a multimedia player, an electronic frame, a digital billboard, a large format display (LFD), a digital signage, a set-top box, or the like. The electronic apparatus 100 has a convenient user interface (UI) for purchasing and paying digital content from the server 200. The user accesses a content store of the server 200 with a first user account through the electronic apparatus 100 to purchase digital content.

The server 200 holds a variety of digital content and operates the content store capable of selling or distributing a content according to a request of a buyer. The server 200 may sell or distribute a digital content based on a selected device and account. The server 200 may be connected to the electronic apparatus 100 or external apparatuses 400-1 to 400-5 via the router 300. The server 200 may provide a digital content list according to a request of a user who logs in with a first user account through the electronic apparatus 100. The server 200 may register or transfer an ownership of digital content purchased by the purchaser through the electronic apparatus 100 with or to at least one external apparatus 400-1 to 400-5 and a second user account designated by a purchaser.

The router 300 connects the electronic apparatus 100 and the external apparatuses 200-1 to 200-5 through a network. The router 300 is an apparatus included in a network layer among seven layers of the open systems interconnection (OPS), and serves to extract a path to packets that needs to pass between a logically separated network or a physically separated network, find a path that the router 300 knows, and then transmit the packets to other networks. The router 300 may also be replaced by a gateway, a sharer, or the like.

The external apparatuses 400-1 to 400-5 may be implemented as, for example, TV1, TV2, a mobile device 2, IoT1, and IoT2. The electronic apparatuses 400-1 to 400-5 may further include, for example, a TV, a computer, a notebook, a smart phone, a tablet, a mobile phone, a smart watch, a wearable device, a computer, a multimedia player, an electronic frame, a digital billboard, a large format display (LFD), a digital signage, a set-top box, or the like. The external apparatuses 400-1 to 400-5 are also IoT devices and may include an air conditioner, an audio system, a refrigerator, a lighting lamp, a door lock, a camera, and the like. The external apparatuses 400-1 to 400-5 may receive digital content that a user purchases from the server 200 with the first user account through the electronic apparatus 100 and that is registered or transferred to the second user account.

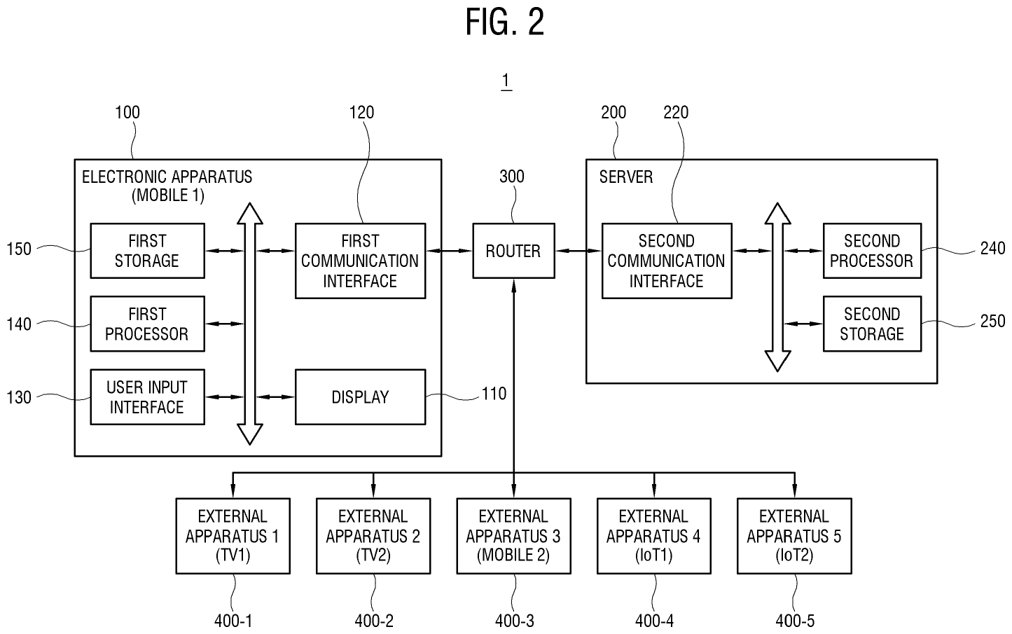

FIG. 2 is a block diagram of a system 1 for purchasing, selling, and using digital content of FIG. 1.

As illustrated, the electronic apparatus 100 includes a display 110, a first communication interface 120, a user input interface 130, a first processor 140, and a first storage unit 150. The electronic apparatus 100 may further include various components such as an image signal processor, a voice signal processor, a speaker, and a microphone (not illustrated).

The display 110 displays an image based on an image signal processed by the image signal processor (not illustrated). The display 110 may display the digital content list received from the server 200 through the first communication interface 120. The user may select desired content through the digital content list displayed on the display 110. When a user selects content that he/she wants to purchase, the display 110 may display external apparatuses 400-1 to 400-5 capable of using or consuming the content and a second user account list through a selectable user interface (UI).

The implementation scheme of the display 110 is not limited, and the display may be implemented in various display panels such as liquid crystal, plasma, a light-emitting diode, an organic light-emitting diode, a surface-conduction electron-emitter, carbon nano-tube, and nano-crystal.

The display 110 may additionally include an additional component according to the implementation scheme. For example, in the case of a liquid crystal type, the display 110 may include a backlight unit (not illustrated) for supplying light and a panel driving substrate (not illustrated) for driving a display panel (not illustrated).

The first communication interface 120 as a communication circuit performs network communication with a plurality of external apparatuses 400-1 to 400-5 through the router 300. The first communication interface 120 may communicate with the server 200 through the router 300 by wireless or wired Internet. The first communication interface 120 may perform direct communication with the server 200 or the external apparatuses 400-1 to 400-5, if necessary.

The first communication interface 120 may include data communication modules such as VDSL, Ethernet, a token ring, a high definition multimedia interface (HDMI), USB, a component, LVDS, and HEC, mobile communications such as 2G, 3G, 4G, long term Evolution (LTE), wireless Internet modules such as a wireless LAN (Wi-Fi), wireless broadband (Wibro), world interoperability for microwave access (Wimax), and high speed downlink packet access (HSDPA), short-range communication modules such as Bluetooth, radio frequency identification (RFID), infrared data association (IrDA), ultra wideband (UWB), and ZigBee, and the like.

The user input interface 130 includes a keyboard, a mouse, a keypad, a touch screen, a microphone, a remote control, or the like that can receive user input. The user input may be received or selected through a user interface displayed on the display 110. The user interface may include a graphic user interface composed of graphics and text, a web user interface that reads and manipulates a web page through the Internet and web browser, a command line interface that inputs a command string to manipulate a system, a haptic interface, a touch user interface, a voice user interface, a gesture interface, a motion tracking interface, and the like.

The first processor 140 displays, for example, information on digital content received from the server 200 through the first communication interface 120 on the display 110. The information on the digital content is received as a web page from the server 200 and is displayed on the display 110 through a UI so that a user may be selected for purchase. When the user selects digital content to be purchased through the UI, the first processor 140 transmits the selected digital content information to the server 200. The first processor 140 receives external apparatuses 400-1 to 400-5 capable of using or consuming the selected digital content and a second user account list from the server 200 and displays the received external apparatuses 400-1 to 400-5 and second user account list on the display 110. The server 200 may provide information on the available external apparatus and the second user account managed by being linked with the electronic apparatus 100 purchasing content and the first user account, thereby allowing the user to easily select the available external apparatus and the second user account. When the user selects his/her desired external apparatuses 400-1 to 400-5 and the second user account in the UI showing the external apparatuses 400-1 to 400-5 displayed on the display 110 and the second user account list, a first processor 140 transmits the information on the external apparatuses 400-1 to 400-5 using or consume content to be purchased and the second user account to the server 200. As a result, when the external apparatus and the user account to be directly used by the user may be designated, and the electronic apparatus 100 may log in with the first user account to purchase digital content, by selecting the external apparatus using the content and the second user account to transfer the ownership of the content, it is possible to designate and purchase a content using apparatus and account with the content purchasing device and account.

Optionally, when the user selects digital content to be purchased through the UI, the first processor 140 searches the external apparatuses 400-1 to 400-5 capable of using or consuming the digital content and the second user account in the network. The external apparatuses 400-1 to 400-5 capable of using or consuming the digital content and the second user account may be searched from the information stored in the router 300 or the information stored in the external apparatuses 400-1 to 400-5. In this way, the first processor 140 may acquire the information on the external apparatus searched within the network, so the electronic apparatus 100 may conveniently search the information on at least one of the external apparatuses capable of using the content purchased through the network and the second user account. The first processor 140 displays the searched external apparatuses 400-1 to 400-5 and second user account list on the display 110 through the UI. Accordingly, the user may easily select the available external apparatus and the second user account at the time of purchase. When the user selects the external apparatuses 400-1 to 400-5 using or consuming digital content and the second user account from the external apparatuses 400-1 to 400-5 and the second user account list of the UI displayed on the display 110, the first processor transmits the selected external apparatuses 400-1 to 400-5 and second user account to the server 200 together with the digital content.

The first processor 140 includes at least one general-purpose processor that loads at least a part of the control program from the nonvolatile memory in which the control program is installed into the volatile memory and executes the loaded control program, and may be implemented as, for example, a central processing unit (CPU), an application processor (AP), or a microprocessor.

The first processor 140 may include a single core, a dual core, a triple core, a quad core, or a multiple-number core thereof. The plurality of first processors may be provided, and the first processor may include, for example, a main processor and a sub processor operating in a sleep mode (for example, only standby power is supplied and the electronic apparatus does not operate). In addition, the processor, the ROM, and the RAM can be interconnected via an internal bus.

The first processor 140 may be implemented as a form included in a main SoC mounted on a PCB embedded in the electronic device 1. In another embodiment, the main SoC may further include an image processor (not illustrated).

The control program may include a program(s) implemented in at least one of a BIOS, a device driver, an operating system, firmware, a platform, and an application program (application). The application program may be pre-installed or pre-stored at the time of manufacturing of the electronic apparatus 100, or may be installed based on data of the application program received from the outside when used later. The data of the application program may be downloaded to the electronic apparatus 140 from an external server such as an application market. Such an external server is an example of a computer program product, but is not limited thereto.

The first storage 150 stores unrestricted data. The first storage 150 is accessed by the first processor 140, and performs operations such as reading, writing, modifying, deleting, and updating data by the first processor 16. The data stored in the first storage 150 includes, for example, the information on the external apparatuses 400-1 to 400-5 connected to the network and the second user account, and the like. Obviously, the first memory 150 may include an operating system, various applications executable on the operating system, image data, additional data, and the like.

The first storage 150 may store the information on the digital content that can be used or consumed by the electronic apparatus 100, such as a type, a version, and a manufacturer of content. The first storage 150 may store the information on the digital content that can be used or consumed by the external apparatuses 400-1 to 400-5 connected to the network through the router 300. The information on the digital content that can be used or consumed by the external apparatuses 400-1 to 400-5 may be updated in real time from the external apparatuses 400-1 to 400-5. For example, when at least one hardware or software of the external apparatuses 400-1 to 400-5 is changed, the digital content that can be used or consumed is added or deleted, which may be notified to the router 300, the electronic apparatus 100, or other external apparatuses connected to the network.

The first storage 150 includes a nonvolatile memory in which a control program is installed, and a volatile memory in which at least a part of the installed control program is loaded.

The first memory 150 may include at least one storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The server 200 may include a second communication interface 220, a second processor 240, a second processor 250, and the like.

The second communication interface 220 performs wired or wireless network communication with the electronic apparatus 100 or the plurality of external apparatuses 400-1 to 400-5 through the router 300.

The second communication interface 220 may include data communication modules such as VDSL, Ethernet, a token ring, a high definition multimedia interface (HDMI), USB, a component, LVDS, and HEC, mobile communications such as 2G, 3G, 4G, long term Evolution (LTE), wireless Internet modules such as a wireless LAN (Wi-Fi), wireless broadband (Wibro), world interoperability for microwave access (Wimax), and high speed downlink packet access (HSDPA), short-range communication modules such as Bluetooth, radio frequency identification (RFID), infrared data association (IrDA), ultra wideband (UWB), and ZigBee, and the like.

The second processor 240 performs control to operate the overall configurations of the server 200. The second processor 240 provides the information on the purchasable digital content to the electronic apparatus 100 according to a request of a user who logs in to the first user account through the electronic apparatus 100. When receiving the information on the digital content to be purchased from the electronic apparatus 100, the second processor 240 provides to the electronic apparatus 100 information on general external apparatus capable of receiving the information on the digital content, such as information on a device type, a device model, a device version, and a device manufacturer and the information on the second user account. In this way, the server 200 may provide the information on the available external apparatus and the second user account managed by being linked with the electronic apparatus 100 and the first user account, which purchase the content.

Optionally, when receiving the information on the digital content to be purchased from the electronic apparatus 100, the second processor 240 provides, to the electronic apparatus 100, the information on the external apparatus and the second user account managed by being linked with the electronic apparatus 100 and the first user account stored in the second storage 25. In this case, the second processor 240 connects the external apparatus and the second user account received from the electronic apparatus 100 to the electronic apparatus 100 and the first user account, and stores the external apparatus and the second user account in the second storage 250. In this way, it is possible to manage the information on the available external apparatus and the second user account linked with the electronic apparatus 100 and the first user account, which purchase content.

When receiving the external apparatus using or consuming the digital content to be purchased or the second user account from the electronic apparatus 100, the second processor 240 registers and manages the ownership of the digital content to be purchased with the external apparatus using or consuming the digital content and the second user account. Accordingly, when the user logs in to the first user account through the electronic apparatus 100 to purchases the digital content, the server 200 allows the user to select the external apparatus using the content and the second user account to transfer the ownership of the content, thereby purchasing the content without having to change the content purchase apparatus and account to the content use apparatus and account.

The second processor 240 may store and manage the information on all the external apparatuses of the second user account together with the electronic apparatus 100 of the first user account connected to the server 200 based on a location, for example, GPS. When receiving the digital content information to be purchased from the electronic apparatus 100, the second processor 240 may transmit the information on the external apparatus and the second user account included in the current location or the designated location of the electronic apparatus 100 to the electronic apparatus 100. Accordingly, it is possible to allow the user to select the available external apparatus and the second user account that can be used based on the location. The location information of the electronic apparatus 100 may be transmitted by the electronic apparatus 100, stored in advance, or searched by the second processor 140 in real time. In this way, the electronic apparatus 100 allows the information on the location of the electronic apparatus 100 to be transmitted to the server 200 and receives information on the available external apparatus corresponding to the location of the electronic apparatus 100 from the server 200, so the content to be purchased may be used with an external apparatus at the desired location and the second user account.

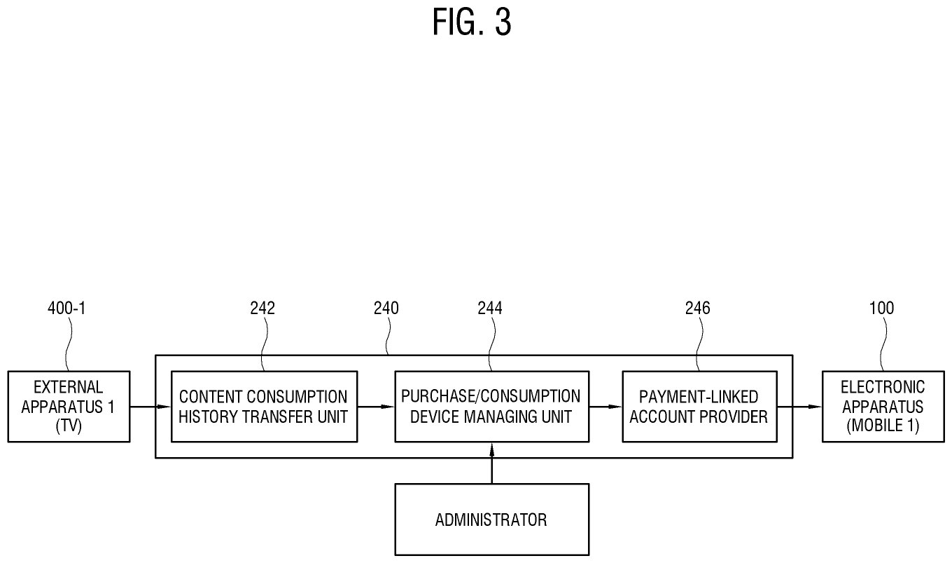

FIG. 3 is a block diagram illustrating the configuration of the second processor 240. As illustrated, the second processor 240 includes a content consumption history transfer unit 242, a purchase consumption device manager 244, and a payment-linked account provider 246. The second processor 240 may execute at least one control program. Accordingly, the above-described content consumption history transfer unit 242, purchase consumption device manager 244, and payment-linked account provider 246 may be implemented in the form of a control program.

The content consumption history transfer unit 242 stores and manages the content consumption history of the external apparatus 1 (TV1) in the second storage 250, for example. In this case, the content consumption history transfer unit 242 may distinguish and manage each second user account of the external apparatus 1 (TV1). That is, the external apparatus 1 (TV1) may be used only as a single second user account or may be used as a plurality of second user accounts.

The purchase and consumption device manager 244 may divide an apparatus that purchases digital content and an apparatus that consumes digital content into user accounts, and may be managed by an administrator.

When the user requests a purchase of a specific digital content, the payment-linked account provider 246 may provide the electronic apparatus 100 with a specific digital content, the information on the external apparatus and the second user account linked with the first user account requesting a purchase.

The second storage 250 stores unrestricted data. The second storage 250 is accessed by the first processor 240, and performs operations such as reading, writing, modifying, deleting, and updating data by the second processor 240. The second storage 250 may include an operating system, various applications executable on the operating system, image data, additional data, and the like.

The second storage 250 stores, for example, the information on all the available external apparatuses linked with digital content, the information on the external apparatuses 400-1 to 400-5 and the second user account stored and managed by being linked with the first user account, or the like. The information on the electronic apparatus 100 or external apparatus 400-1 to 400-5 using or consuming digital content may be updated in real time. For example, the second storage 250 may add or delete digital content that can be used or consumed by changing hardware or software of at least one of the external apparatuses 400-1 to 400-5, thereby updating, storing, and managing the digital content.

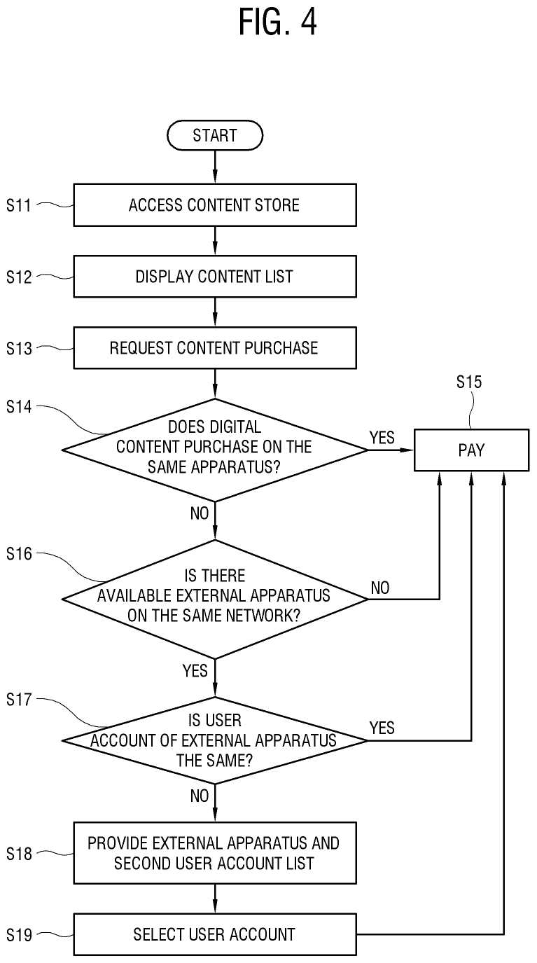

FIG. 4 is a flowchart illustrating a process of purchasing content from a server 200 operating a digital content store.

In step S11, a user logs in with the first user account through the electronic apparatus 100 and accesses the digital content store of the server 200.

In step S12, the digital content list transmitted by the server 200 is displayed on the display 110.

In step S13, the user selects the desired digital content from the digital content list displayed on the display 110 and requests the server 200.

In step S14, it is checked whether to perform the purchase with the electronic apparatus 100 of the first user account.

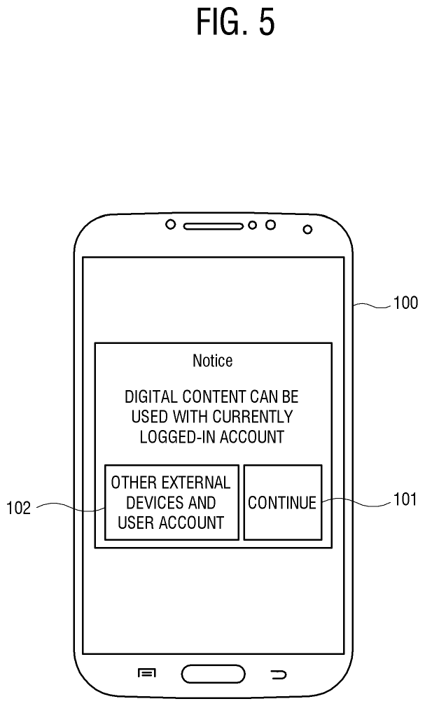

FIG. 5 illustrates the UI displayed on the display 110 when there is an apparatus available for the digital content requested for purchase with the currently logged-in first user account. As illustrated, the user may select a “continue 101” option that selects and progresses the currently logged-in first user account and electronic apparatus 100 as the use apparatus and an “external apparatus and account 102” option that progresses other external apparatuses 400-1 to 400-5 and user accounts.

When the user selects “continue” from the UI and performs the purchase with the electronic apparatus 100 of the first user account, the payment of step S15 is performed, and when the user selects “external apparatus and account”, step S16 is performed.

In step S16, the server 200 checks whether there is the external apparatus that can be used or consumed within the same network as the electronic apparatus 100. If there is no external apparatus that can be used or consumed within the same network as the electronic apparatus 100, the payment of S15 is performed, and if there is the external apparatus, step S17 is performed.

In step S17, the server 200 checks whether the user account of the external apparatus is the same as the first user account of the electronic apparatus 100. If the user account of the external apparatus is the same as the first user account of the electronic apparatus 100, the payment of S15 is performed, and otherwise, step S18 is performed.

In step S18, the server 200 provides the electronic apparatus 100 with the external apparatus capable of using or consuming the purchased digital content and the second user account list.

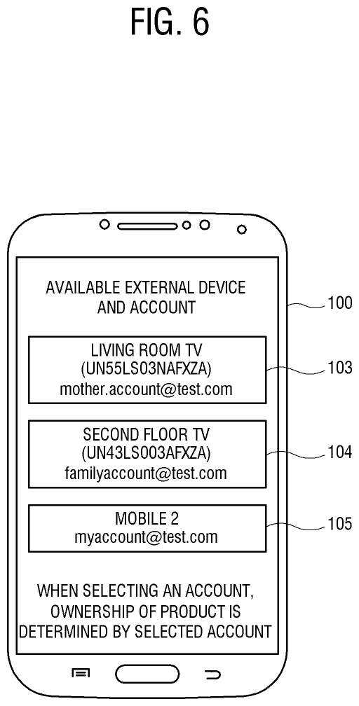

FIG. 6 illustrates the UI indicating the external apparatus capable of using or consuming the digital content and the second user account list. As illustrated, the UI indicates external apparatus 1 “living room TV and second user account mother.account@test.com 103 of the living room TV”, external apparatus 2 “second floor TV and second user account “familyaccount@teat.com 104”, and external apparatus 3 “mobile 2 and second user account “myaccount@test.com 105”, and the user may select at least one of them. When the user selects a plurality of external apparatuses and user accounts, the server 200 may be allowed through additional billing, if the purchaser wants.

In step S19, the desired external apparatus and second user account are selected from the external apparatuses capable of using or consuming the digital content and the second user accounts, and the payment of step S15 is performed.

The server 200 may push and transmit the purchased digital content to the selected external apparatus and second user account. Accordingly, the server 200 may provide digital content to the external apparatus having ownership of the purchased content and the second user account. Optionally, the server 200 may notify a mobile, computer, or TV used by the user of the selected external apparatus or external apparatus with a message indicating that specific content has been purchased with the first user account and ownership has been transferred. In particular, for example, when the external apparatuses 400-4 and 400-5 such as IoT 1 and 2 may only receive content in one direction, the digital content purchased may be pushed and transmitted to the router 300 or the IoT server (not illustrated).

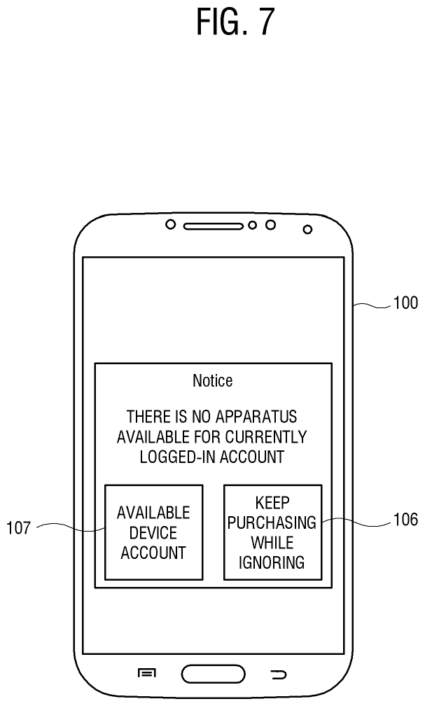

FIG. 7 illustrates the UI displayed on the display 110 when there is no apparatus available for the digital content requested for purchase with the currently logged-in first user account. As illustrated, the user may select a “keep purchasing while ignoring 106” option that selects and progresses the currently logged-in first user account and electronic apparatus 106 as the use apparatus and an “available external apparatus and account 107” option that progresses other external apparatuses 400-1 to 400-5 and user accounts. The user may select the “keep purchasing while ignoring 106” when purchasing a new electronic apparatus capable of using or consuming the corresponding digital content with the first user account, or when upgrading hardware or software is scheduled. The user may select “available external apparatus and account 107” when he/she wants to select the external apparatus and the second user account that he/she wants to use or consume. The user may directly input the external apparatus and the second user account that he or she wants to use or consume or receive the information on the external apparatus and the second user account managed from the server 200, or search the electronic apparatus 100 from the external apparatuses 400-1 to 400-5 or the router 300 within the network.

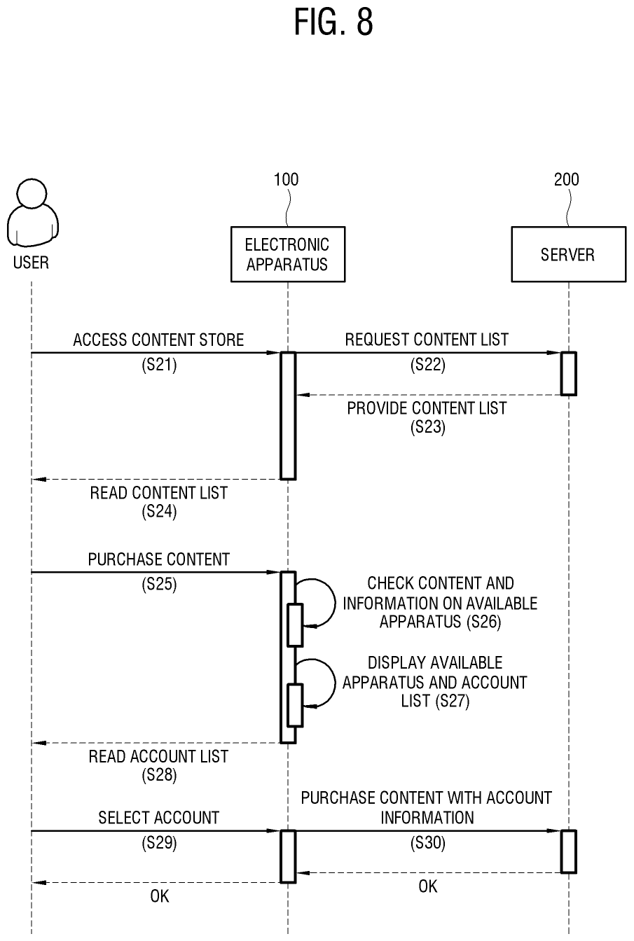

FIG. 8 is a flowchart of a scenario for purchasing, selling, and using digital content according to a second embodiment of the disclosure.

In step S21, a user logs in with the first user account through the electronic apparatus 100 and accesses the digital content store of the server 200.

In step S22, the electronic apparatus 100 requests a digital content list from the server 200.

In step S23, the server 200 transmits the digital content list to the electronic apparatus 100.

In step S24, the digital content list transmitted by the server 200 is displayed on the display 110 and is read by a user.

In step S25, the user selects desired digital content from the digital content list displayed on the display 110.

In step S26, the digital content selected by the electronic apparatus 100 and information on an apparatus capable of using or consuming the selected digital content, such as the electronic apparatus 100 itself or external apparatuses 400-1 to 400-5 connected to the same network, and user accounts, are searched.

In step S27, the digital content and the information on the apparatus capable of using or consuming the searched digital content, such as the electronic apparatus 100 itself or external apparatuses 400-1 to 400-5 connected to the same network, and a user account list, which are searched by the electronic apparatus 100, are displayed on the display 110. The external apparatuses 400-1 to 400-5 and the user account list may be displayed as illustrated in FIG. 6 described above.

In step S28, a user reads the external apparatuses 400-1 to 400-5 and the user account list that are displayed on the display 100.

In step S29, the user selects the external apparatus that wants to use or consume the display content and the second user account.

In step S30, the electronic apparatus 100 purchases the selected digital content with the external apparatus and the second user account selected from the content store of the server 100.

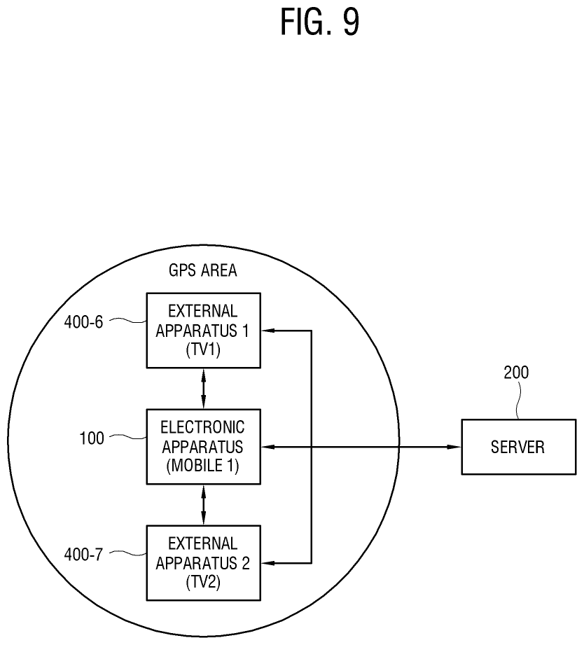

FIG. 9 is a schematic diagram of a system for purchasing, selling, and using digital content according to a third embodiment of the disclosure. As illustrated, the user purchases the digital content from the server 200 through the electronic apparatus 100. In this case, the user may display event content such as a proposal on an external apparatus existing at a specific location, for example, on the large screens (TV1) 400-1 and 400-2.

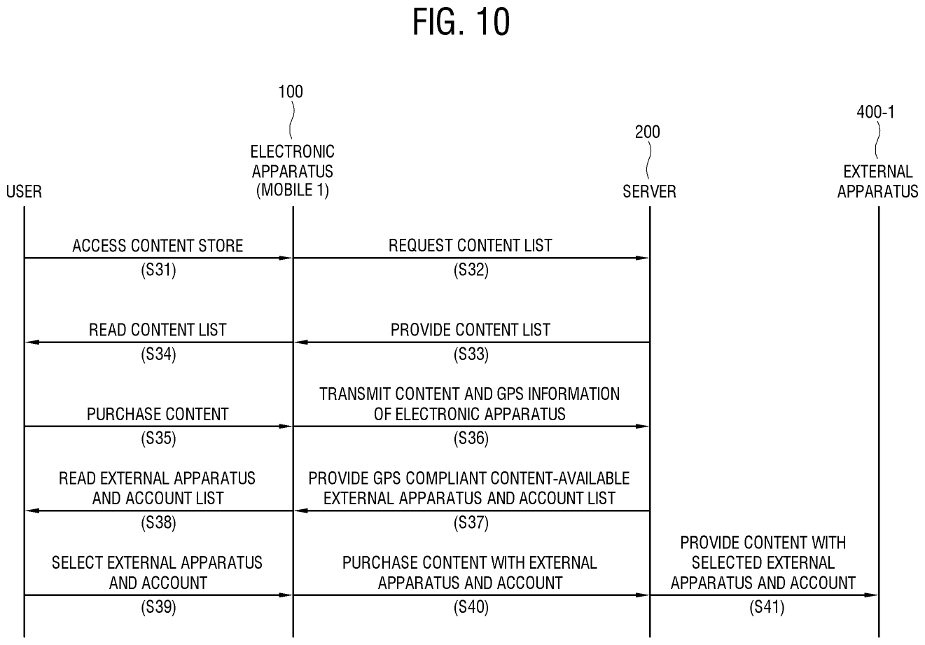

FIG. 10 is a flowchart illustrating a scenario of purchasing, selling, and using digital content in the system of FIG. 9.

In step S31, a user logs in with the first user account through the electronic apparatus 100 and accesses the digital content store of the server 200.

In step S22, the electronic apparatus 100 requests the digital content list from the server 200.

In step S33, the server 200 provides the digital content list to the electronic apparatus 100.

In step S34, the digital content list transmitted by the server 200 is displayed on the display 110 and is read by a user.

In step S35, the user purchases the desired digital content from the digital content list displayed on the display 110.

In step S36, the electronic apparatus 100 transmits content information to be purchased and GPS information of the electronic apparatus 100 to the server 200. Here, the GPS information may include all information capable of finding a location such as an address and a zip code as an example.

In step S37, the server 200 transmits the external apparatuses 1 and 2 (400-1 and 400-2) located in the GPS area and the user account list to the electronic apparatus 100. Here, the GPS area may be an area including an error range or a randomly set area. The server 200 may transmit user information, such as a user name, a phone number, and a mail, along with external apparatuses 1 and 2 (400-1, 400-2) and the user account.

In step S38, the electronic apparatus 100 displays the external apparatus 400-1 and the user account list on the display 110 so that the user reads the desired external apparatus 400-1 and user account list.

In step S39, the user selects the desired external apparatus 400-1 and user account from the external apparatus 400-1 and the user account list.

In step S40, the electronic apparatus 100 purchases digital content with the external apparatus 400-1 and the user account selected by the user. As a result, the user may use the content to be purchased as the external apparatus and the second user account at a desired location. In step S37, when the server 200 transmits only the information on the external apparatus 1 and 2 (400-1, 400-2), the user account and user information are transmitted to the server 200 together with the information on the specific external apparatus 400-1 selected by the user to perform the purchase of the digital content. In this case, the user may acquire a use right from the selected specific external apparatus 400-1 in advance or acquire the use right from the server 200. The server 200 may further perform a process of registering an external apparatus capable of using or consuming content and a user account based on the received user account and user information.

In step S41, the server 200 provides the purchased digital content to the selected external apparatus 400-1 and user account.

Although the preferred embodiments of the disclosure have been illustrated and described above, the disclosure is not limited to the specific embodiments described above, and can be variously modified by those skilled in the art to which the disclosure pertains without departing from the gist of the disclosure claimed in the claims, and these modifications should not be understood individually from the technical ideas or prospects of the disclosure.

1. An electronic apparatus, comprising:
a display;
a communication interface configured to communicate with a server;
a user input interface configured to receive a user input; and
a processor configured to:
based on a user input requesting a purchase of the digital content via a logged-in first user account, receive information on purchasable digital content from the server,
control the display to, based on the received information on the purchasable digital content, display a user interface (UI) indicating the information on the purchasable digital content and information on an external apparatus and a second user account of the external apparatus, which are capable of using the digital content, and
based on the user input using the UI, transmit information on a digital content selected to be purchased and information on selected external apparatus and second user account to the server.

2. The electronic apparatus of claim 1,
wherein the communication interface is configured to perform network communication with the available external apparatus through a router, and
the processor is configured to obtain the information on the external apparatus searched in the network.

3. The electronic apparatus of claim 2,
wherein the processor is configured to search for the second user account of the external apparatus and display the UI indicating the information on the second user account of the external apparatus on the display.

4. The method of claim 1,
wherein the available external apparatus and a second user account list of the external apparatus are transmitted from the server.

5. The electronic apparatus of claim 1,
wherein the external apparatus includes an IoT device, and
the server is configured to provide the purchased digital content to a server of the IoT device.

6. The electronic apparatus of claim 1,
wherein the processor is configured to transmit information on a location of the electronic apparatus to the server, and receive information on an available external apparatus corresponding to the location of the electronic apparatus from the server.

7. The electronic apparatus of claim 1,
wherein the information on the selected external apparatus and the second user account is received by the user input.

8. A server, comprising:
a communication interface configured to communicate with an electronic apparatus;
a processor configured to:
based on a purchase request for digital content of the electronic apparatus logged in with a first user account, transmit information on purchasable digital content to the electronic apparatus, and
receive from the electronic apparatus, information on digital content to be purchased and information on an external apparatus using the digital content to be purchased and a second user account of the external apparatus, and register the information on the digital content to be purchased with the second user account of the external apparatus to be used.

9. The server of claim 8,
wherein the processor is configured to transmit information on an external apparatus and a second user account of the external apparatus, which are capable of using the digital content, to the electronic apparatus.

10. The server of claim 8, further comprising:
a storage,
wherein the processor is configured to connect the external apparatus and the second user account received from the electronic apparatus, to the electronic apparatus and the first user account, and store the external apparatus and the second user account in the storage.

11. The server of claim 10,
wherein the storage is configured to, based on a location, store the information on the external apparatus and the second user account, which are capable of using the digital content.

12. The server of claim 8,
wherein the processor is configured to, upon receiving information on a location of the electronic apparatus, transmit information on an external apparatus and a second user account capable of using in response to a location of the electronic apparatus, to the electronic apparatus.

13. The server of claim 8,
wherein the processor is configured to push and transmit the digital content to the external apparatus and the second user account.

14. A method of purchasing digital content, comprising:
logging in to a server with a first user account to request a purchase of purchasable digital content;
receiving information on the purchasable digital content from the server;
based on the received information on the purchasable digital content, displaying, on a display, a user interface (UI) indicating the information on the purchasable digital content and information on an external apparatus and a second user account of the external apparatus, which are capable of using the purchasable digital content; and
based on a user input using the UI, transmitting information on a digital content selected to be purchased and information on an external apparatus and an second user account selected to use the digital content to the server.

15. The method of claim 14, further comprising:
transmitting location information of the electronic apparatus to the server; and
searching available external apparatus and second user account based on the location information.
